(19) United States
(12) Patent Application Publication
(10) Pub. No.: US 2005/0021351 A1
(43) Pub. Date: Jan. 27, 2005

(54) Charging in a communication system

(75) Inventors: Juha-Pekka Koskinen, Hameenlinna (FI); Juha R. Vallinen, Tampere (FI); Anne Narhi, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/683,351

(22) Filed: Oct. 14, 2003

(30) Foreign Application Priority Data
Jul. 22, 2003 (GB) 0317124.6

(51) Int. Cl. G06F 17/60

(52) U.S. Cl. 705/1; 705/400

(57) ABSTRACT

A method for charging users in a communication system includes initiating set-up of a communication session between a first party and a second party by sending, from the first party associated with a first charging entity to the second party associated with a second charging entity, a message inviting the second party to joint the communication session. The method further includes sending a response to the message that includes information regarding the second charging entity, and based on the response, providing the first charging entity with the information regarding the second charging entity. Lastly, the method includes establishing a communication interface between the first and second charging entities based on the information from the response. A system is also disclosed for performing the method. The response may use session initiation protocol (SIP).

### BACKGROUND OF THE INVENTION

1. Field of the Invention

The present invention relates to charging in a communication system, and in particular to charging of communication sessions.

2. Description of the Related Art

A communication system can be seen as a facility that enables communication between two or more entities such as user equipment and/or other nodes associated with the system. The communication may comprise, for example, communication of voice, data, multimedia and so on.

In a basic communication system a simple communication network is provided for linking together two user equipment so that the users of the user equipment can communicate with each other during a communication session. The session may also be referred to by the term call. At least some set-up signalling is typically required in order to set-up a communication session. Communication between the user equipment and the entities of the communication network and the set-up signalling can be based on an appropriate communication protocol or protocols.

Conventionally, a designated charging entity in the network uses a stored tariff to determine a charge for a call or other session based on the duration of the session. Each user typically has at least some sort of charging arrangement, for example, a charging account with the operator of the network. Such a user can be referenced to as the subscriber. The charge for a session may then be allocated to the charging account of the user that originated, i.e., initiated the session.

When a communication session is in progress the network may use the tariff to allocate charges due for the session or use of other services. In post paid arrangements the charges for use of the communication services are typically charged after a specified period of time, such as monthly. In pre-paid accounts the charges are collected beforehand.

The prepaid communication accounts are becoming increasingly popular. Under a pre-paid account scheme a user pays in advance for communication services. As the user makes use of services the charges for those services are deducted from the balance of the prepaid account until the balance has diminished to zero. Then the network blocks the usage of services by the user until the account has been topped up. Pre-paid services have an advantage in that the network operator does not need to trust the user to pay in arrears for services, as is the case with post paid accounts. Users may also prefer the prepaid accounts since they enable an easy way of controlling the costs of using the communication services. The prepaid account may also offer anonymity for the users.

Various and ever increasing number of services are available for the users of communication systems. An example of the services that might be offered via a communication system is the so called multimedia services. An example of communication systems enabled to offer the multimedia services for the users are IP (Internet Protocol) Multimedia networks. IP Multimedia (IM) functionalities can be provided by means of an IP Multimedia Subsystem (IMS). The data to be communicated in the multimedia application may comprise various types of data. For example, voice, video or other image data, streaming data, text data and other content data may be communicated between the parties of the communication via a communication system.

The large variety of services and types of communication introduced by various applications in the IMS may require improved flexibility from the charging functions. For example, use of prepaid charging may require online communication between different charging entities in cases where charging responsibility does not necessarily lie on the user originating the communications.

However, in conventional IMS networks it is not possible for charging entities to communicate with each other. Therefore there is a need for a mechanism that enables communication between different charging entities.

Furthermore, in some IMS applications it may be required that it is possible to use the so called ‘collect call’—type charging i.e., charging, wherein the called party is charged for at least a part of the costs. This type of charging is also known as reversed charging.

In typical reversed charging applications the called party is made aware of any requests for reversed charging. Thus information associated with the charging may need to be transferred between the parties, and not just within the network or networks handling the call. This means that an end-to-end charging mechanism may need to be provided. However, some communication facilities such as the Internet Multimedia Subsystem networks are not capable of handling the messaging required for the reverse charging.

There is therefore a need to provide for enhanced and more flexible charging capability in communication networks.

### SUMMARY OF THE INVENTION

Embodiments of the present invention aim to address one or several of the above problems.

According to one aspect of the present invention, there is provided a method for charging in a communication system, the method method including the steps of initiating set-up of a communication session between a first party and a second party by sending from the first party to the second party a message inviting the second party to join the communication session, the first party being served by a first charging entity and the second party being served by a second charging entity. The method further includes sending a response to the message, the response including information regarding the second charging entity, and based on the response, providing the first charging entity with information regarding the second charging entity. A communication interface is then established between the first and second charging entities based on the information included in the response.

According to another aspect of the present invention there is provided a communication system which includes a first charging entity configured to charge a first user equipment for use of communication resources provided by the communication system, and a second charging entity configured to charge a second user equipment for use of communication resources provided by the communication system. The system further includes a first control entity configured to serve the first user equipment, and a second control entity configured to serve the second user equipment, wherein at least one of the control entities is configured to provide the associated charging entity with information regarding the other charging entity, and, in response to receiving such information, to initiate set-up of a communication interface between the first and second charging entities.

According to yet another aspect of the present invention user equipment is configured to include information regarding charging of a session in a message generated in response to an invitation to join the session.

According to yet another aspect of the present invention a network entity is configured to serve a first user equipment, to provide a first charging entity serving the first user equipment with information regarding a second charging entity serving a second user equipment in response to receiving such information from a controller serving the second user equipment.

According to yet another aspect of the present invention a network entity is configured to serve a user equipment and to include into a message from the user equipment to another network entity information regarding a charging entity serving the user equipment.

According to yet another aspect of the present invention there is provided a charging entity for a communication system, the charging entity being configured to serve a first user equipment and to communicate with another charging entity configured to serve a second user equipment, the communication being based on information regarding the second charging entity and received from a controller of the communication system.

In more specific embodiments of the invention the second party is charged based on information communicated on the communication interface between the charging entities.

In one implementation of the invention, session initiation protocol (SIP) messaging may used for the exchange of information.

Information regarding the second charging entity may be included at a controller entity serving the second party. At least a part of information required for the establishment of the communication interface between the first and second charging entities may be included into the response by the second party.

Signalling may occur on at least two networks.

A message inviting the second party to join a communication session may include an indication that the second party is requested to pay for at least a part of the charges for the session. At least one condition for the payment by the second party may also be included.

The embodiments of the invention may provide a more flexible mechanism for charging in communication systems. For example, one embodiment may enable use of charging methods such as divided charging responsibility, reverse charging, sponsored charging and so on together with prepaid charging. An advantage is the provision of the possibility to establish reverse or divided charging with online negotiations. The need to use any B-number analysis or pre-definitions to enable this feature may be avoided. If prepaid charging is used, embodiments of the invention may provide a possibility for the calling party, i.e., A-party, to use the normal telephone number of the called party, i.e., B-party, even in instances where the B-party is paying at least a part of the costs.

### BRIEF DESCRIPTION OF THE DRAWINGS

For better understanding of the present invention, reference will now be made by way of example to the accompanying drawings in which:

FIG. 1 shows an embodiment of the invention;

FIG. 2 is a flowchart in accordance with an embodiment of the invention;

FIGS. 3 and 4 are signalling flowcharts exemplifying operation of some embodiments of the invention; and

FIG. 5 shows a multi-network communication system wherein the invention may be embodied.

### DETAILED DESCRIPTION OF THE PREFERRED EMBODIMENTS

The present invention will be described by way of example with reference to the architecture of a third generation (3G) mobile communications system. However, it will be understood that it can be applied to any other suitable form of network.

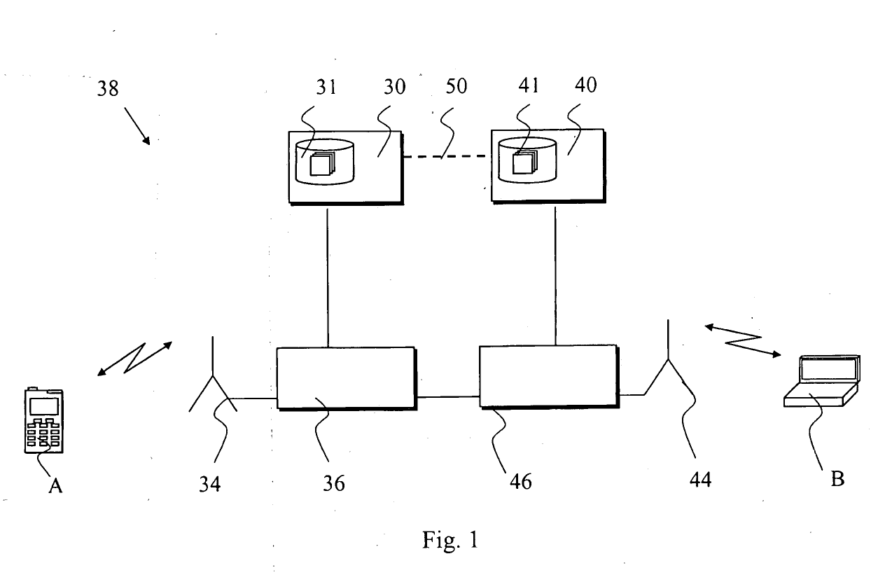

Reference is made first to FIG. 1 which shows a schematic presentation of some elements of a communication system 38 wherein the present invention may be embodied. The mobile communication system is arranged to serve a plurality of mobile user equipment A and B via a wireless interface between the user equipment and respective base stations 34 and 44 of the communication system 38. The communication system may comprise at least one mobile communication network.

A mobile user equipment is configured for wireless communication with other stations, typically with the base stations of a mobile communication system for enabling mobility thereof. The basic operational principles of the mobile user equipment, that may also be referenced to as a mobile station, are known by the skilled person. A user may use the mobile user equipment for tasks such as for making and receiving phone calls, for receiving and sending data from and to the network and for experiencing, for example, multimedia content.

A mobile user equipment may include an antenna element for wirelessly receiving and transmitting signals from and to the base stations of the mobile communication network. A mobile user equipment may also be provided with a display for displaying images and other graphical information for the user of the mobile user equipment. Speaker components are also typically provided. The operation of the mobile user equipment may be controlled by means of an appropriate user interface such as control buttons, voice commands and so on. Furthermore, a mobile station is typically provided with a processor and a memory. Communication between the user equipment and the entities of the communication network can be based on any appropriate communication protocol. An example of such protocol is the session initiation protocol (SIP).

Any appropriate mobile user equipment adapted for Internet Protocol (IP) communication may be used to connect to an Internet Multimedia Subsystem (IMS). For example, a user may access the IMS by means of a Personal Computer (PC), Personal Data Assistant (PDA), mobile station (MS) and so on.

It shall be appreciated that although one user equipment per base station is shown in FIG. 1 for clarity, a number of user equipment may be in simultaneous communication with each base station.

A mobile communication system, in turn, may logically be divided between a radio access network (RAN) and a core network (CN). In the simplified presentation of FIG. 1 the base stations 34 and 44 belong to the respective radio access networks. It shall be appreciated that a plurality of user equipment may be served by a radio access network (RAN). It shall also be appreciated that although FIG. 1 shows the base stations of two radio access networks for clarity reasons, a typical communication network system comprises a number of radio access networks.

The 3G radio access network (RAN) is connected to appropriate core network entity or entities, such as to a serving general packet radio service support node (SGSN) and appropriate control entities such as call state control functions (CSCF). FIG. 1 shows, for clarity reasons, only two core network controller entities 36 and 46 serving user equipment A and B, respectively.

The recent developments in communication systems include-provision of various service control functions by network entities known as servers rather than conventional switches and exchanges. For example, in the current third generation (3G) wireless multimedia network architectures several different servers are used for handling different control functions. These include control functions such as the call state control functions (CSCFs).

The call state control function entities may provide different functions such as a proxy call state control function (P-CSCF), interrogating call state control function (I-CSCF), and/or serving call state control function (S-CSCF). It shall be appreciated that the CSCFs may also be referenced to by other names, such as the call session control functions. The serving call state control function forms the entity the subscriber needs to be registered at in order to be able to request for a service from the communication system. In addition to the serving control entity, the user may need to be associated with one or more proxy and interrogating control entities.

FIG. 1 shows also two charging entities 30 and 40. The charging entity 30 is for the charging of the user equipment A and charging entity 40 is for the charging of the user equipment B. Each of the charging entities 30, 40 is shown to provide a database 31, 41 for storing prepaid accounts for the users A and B, respectively. An interface 50 provided between the charging entities 30 and 40 is also shown.

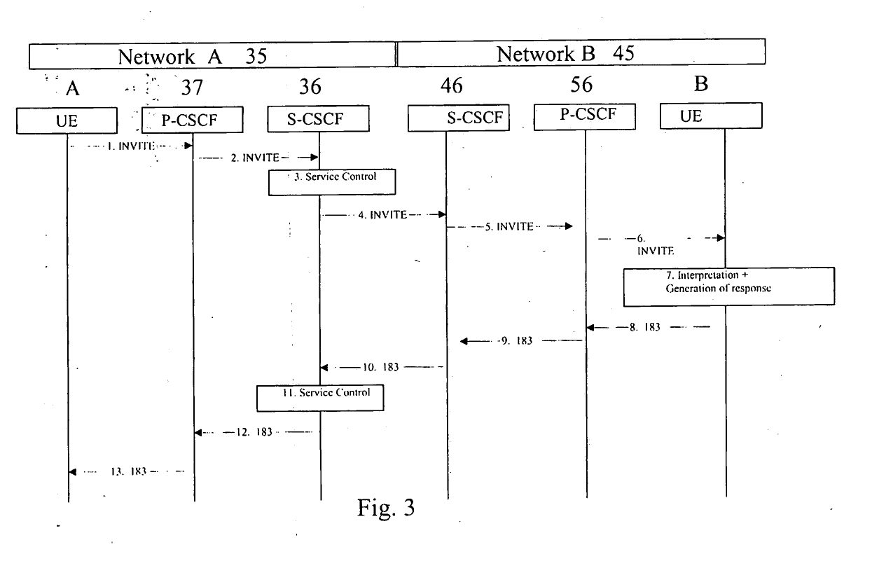

In the more detailed embodiments described below with reference to FIGS. 3 to 5 the controller entities 36 and 46 provide the serving call state control functions for the user equipment A and B, respectively.

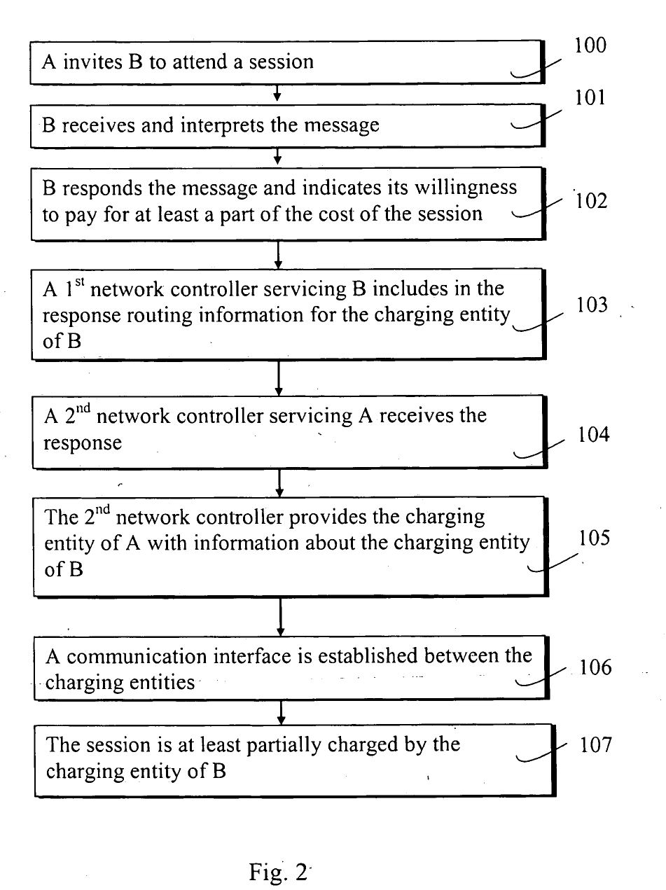

An embodiment is now described with reference to the flowchart of FIG. 2 and signalling flowchart of FIG. 3. This embodiment relates to a situation wherein the user of the user equipment A, i.e., the A-party, initiates set-up proceedings for a session with the user equipment B, i.e., the B-party, by inviting the B-party to join the session at step 100. If A-party wishes that reverse charging is applied for the session, i.e. if the A-party wants the B-party to pay at least a part of the costs incurred during the session, the A-party may request for reverse charging in this initial request for the session.

In FIG. 3 the user equipment A and B are shown to be located in two different networks 35 and 45, respectively. Thus the charging entities responsible for the charging of users A and B may also be located in different networks.

In a pre-paid system it may be necessary to be able to stop a user from using services when the balance of his or hers prepaid account falls to zero. In the simplest form this can be achieved by accounting either an estimated charge or real charge for a session whilst it is in progress, comparing that charge with the remaining balance of the pre-paid account that is to be charged for the call and terminating the session if the charge exceeds the remaining balance. In more complex communication systems, for example communication systems according to the GSM (Global System for Mobile) or UMTS (universal mobile telecommunications system) standard or other standards for third generation (3G) communication systems the networks of more than one operator may be used for carrying a call. Operators of all of those networks may be able to levy charges independently for the services they provide in supporting the call. A system of this sort should be able to reliably apply to the correct account for the charges made by a number of operators for a single session. Furthermore, if in a system having more than one network the network of the user who is to be charged for the session would have to be able to track the ongoing charge for a session as it was in progress even though the charges for the session derived from a number of operators. Otherwise, the session might be allowed to continue when its cost exceeded the user's pre-paid balance and/or not all charges from different networks might be charged from an appropriate prepaid account.

An example how to provide the reversed charging using the session initiation protocol (SIP) in a system having a plurality of networks is now described with reference to FIGS. 2 and 3. FIG. 3 shows signalling flow during the initial signalling phase of the session initiation protocol (SIP). More particularly, FIG. 3 shows signalling of messages 1, 2, 4 to 6, 8 to 10, 12, and 13 between user equipment A and B connected to two different networks 35 and 45, respectively, during session set-up messaging signalling and before the actual voice call session is set up.

The information about a collect call may be inserted to SIP messages, for example, as a specific charging information element (CIE). The information may also be included in an extended mark-up language XML document body. The online accounting session(s) (A-party and/or B-party) may then be updated based on the information from the SIP messages.

More particularly, when negotiating reverse charging by means of SIP signalling, a charging information element (CIE) may be provided with information interpretable by the networks entities, such as the call state control function servers. The request for reversed charging may be generated and inserted to a SIP ‘INVITE’ message 1 by the A-party user equipment. An indication of the request may be included to the subject field of the INVITE message. Another possibility is to use an indication embedded in the message body.

The request may then be transported to the B-party together with the SIP ‘INVITE’ message. The INVITE message may be forwarded in messages 2 and 4 to 6 to the B-party user equipment via appropriate network entities such as proxy and serving call state control functions 37, 56, 36 and 46. The serving call state control function 36 may perform service control operations at control step 3.

The message 6 is received at the B-party user equipment at step 101 of FIG. 2, see also message 7 of FIG. 3. At this stage the indication may be interpreted by the B-party user equipment as a request for reverse charging and an appropriate response may be generated.

If at least a part of the cost of the requested session is to be paid by means of the prepaid account 41 of the B-party, information that enables such charging is preferably made available online already from the beginning of the connection. This may be required in order to be able to charge B-party correctly and in real time from the beginning of the connection. It may also be advantageous to be able to check if the prepaid account 41 of the B-party has enough funds for covering the cost, or indeed, if any valid account exists.

The B-party user equipment may include an indication of its willingness to at least share the costs in the response message 8 of FIG. 3. This information may then be transferred from the B-party user equipment to network entities associated with the B-party. In FIG. 2 this is done at step 102.

One of the network entities, for example the S-CSCF 46 of the B network 45, may then detect that the request for reversed charging has been accepted. In response to the detection the network entity may then include further information in the response message, see step 103 of FIG. 2. In FIG. 3 the CSCF 46 may include the further information in message 10 to CSCF 36.

The further information preferably includes the address of the B-party charging entity 40. The address may be, for example, an IP address or SIP URI (Uniform Resource Identifier) of the charging entity 40. This information is typically available in a controller element that has been assigned to service a user equipment.

The B-party may accept the request for reversed charging received with the SIP ‘INVITE’ message 6, for example, by sending back a SIP ‘183’ (“session in progress”) message 8. Another possibility, if SIP signaling is used, is to send the required charging information in a SIP ‘200OK’ message. The request may also be rejected by the B-party, for example by sending a SIP ‘BYE/CANCEL’ as a response.

The network controller entity 36 serving the A-party receives at step 104 of FIG. 2 the information regarding the charging entity of the B-party in message 10. This information may be forwarded at step 105 to the charging entity 30 of the A-party (see also the service control step 11 of FIG. 3). For example, the receipt of the SIP ‘183’ message 10 at the serving CSCF 36 may be used to trigger a message requesting for charging at control, step 11 of FIG. 3 to the charging entity 30 of subscriber A. This request message may be, for example, a ‘INTERIM RECORD’ or ‘UPDATE REQUEST’ message in accordance with the Diameter protocol. The request message may include ‘collect call parameters’ request and the address of the B-party charging entity.

The A-party charging entity can then contact the charging entity of the B-party by using the received address information. By means of this mechanism it is possible to set up at step 106 the interface 50 of FIG. 1 for transfer of charging information between the charging entities 30 and 40 of A and B parties. The B party may then be charged at step 107 at least partially for the session based on information transferred on the interface 50.

The accounting sessions between the charging entity 30 and the network elements serving the A-party and the charging entity 40 and/or network elements serving the B-party may be set up in any appropriate manner. An important consideration in this embodiment is that the charging entity 30 may start charging session with the charging the entity 40 so that at least a part of the charging may be accomplished at the B-party charging entity 40. Transfer of address information between the A-party network element 36 and the B-party network element 46 as well as between the charging entities may be based on any appropriate protocol, such as the Session Initiation Protocol (SIP) or the Diameter protocol.

The Diameter defines charging applications such as Accounting and Credit-control. Messages such as ‘Accounting-Request’ (ACR), ‘Accounting-Answer’ (ACA), ‘START_RECORD’, ‘INTERIM_RECORD’, ‘STOP_RECORD’ and ‘EVENT_RECORD’ are also defined. These are typically used for post paid cases. The Credit-control applications may use messages such as ‘Credit-Control-Request’ (CCR), ‘Credit-Control-Answer’ (CCA), ‘INITIAL_REQUEST’, ‘UPDATE_REQUEST’, ‘TERMINATION_REQUEST’ and ‘EVENT_REQUEST’ may be used, especially for prepaid charging.

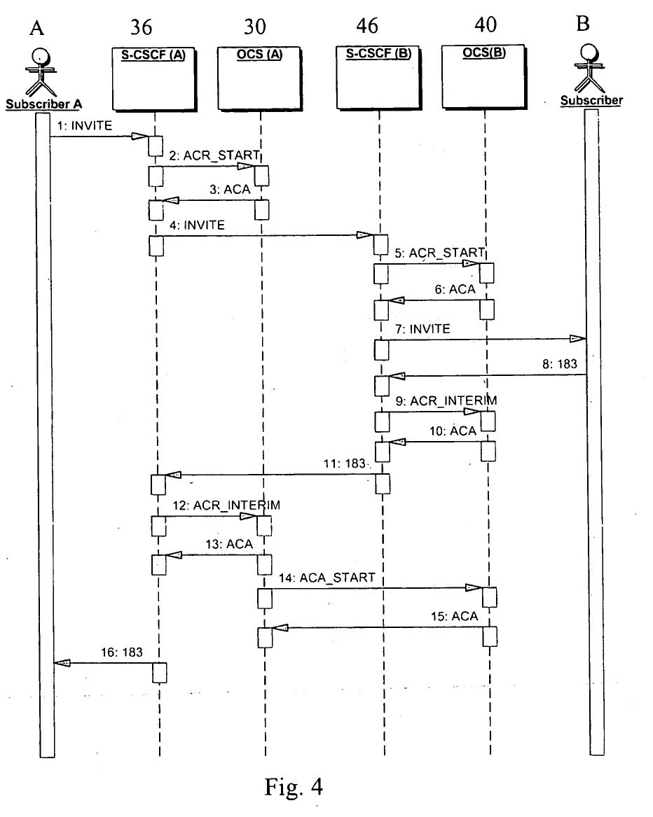

FIG. 4 shows another exemplifying signalling flow chart for the negotiation and for setting up the charging for a session and for interaction between A-party and B-party network elements. As above, in response to the acceptance by the B-party to pay in message 8, the B-party serving controller 46 adds B-party charging entity address information to a SIP ‘183’ message 11 that is transferred to the appropriate A-party network entity 36. Other information may also be transferred. For example, the B-party user equipment may add ‘collect call’ information in message 8.

In this embodiment, a first accounting request message 2 may be sent to the charging entity 30 serving the A-party already when the call state control function 36 receives the SIP ‘INVITE’ message 1. Message 2 may be, for example, a Diameter accounting request message (‘START RECORD’) or a Diameter credit control request message (‘INITIAL REQUEST’). This message may be triggered by the SIP ‘INVITE’ message 1. By means of this type of operation it is possible to start collecting charging data before the SIP ‘INVITE’ message has been forwarded further in the system. Similarly, when the serving call state control function 46 of the B-party receives the SIP ‘INVITE’ message 4 from the A-party, it may send appropriate charging request message 5 to the B-party charging entity 40.

In response to the SIP ‘INVITE’ message 7 the B-party sends a SIP ‘183’ response 8. This message may include information regarding the acceptance and possible conditions for the acceptance.

FIG. 4 shows possible messages 5, 6, 9, and 10 between the serving controller 46 and the B-party charging entity 40. Messages 5 and 6 may relate to “normal” charging operations. Messages 9 and 10 may relate to an update informing the charging entity that B-party is to be charged for the call. This may be required, for example, for security reasons. The B-party charging entity 40 may be configured such that is does not start any charging based on a request from other charging entities unless it has received a confirmation from the serving controller 46 that the session really exists and that the B-party has agreed to pay.

When the A-party S-CSCF 36 receives message 11, it sends a new charging request message 12 to the A-party charging entity 30 for updating the charging information. The updated charging information includes the address of the B-party charging entity. This address may then be used by the A-party charging entity 30 for setting up a communications interface between the two charging entities, see messages 14 and 15. The A-party charging entity 30 may start a new charging session with the B-party charging entity 40, for example; based on the Diameter protocol.

In prepaid cases the collect call information is advantageously available from the beginning of the session. This can be achieved when the information is transferred in the session set-up signalling phase, as shown in FIGS. 3 and 4. As the SIP can be used in the Internet Multimedia Systems (IMS) for signalling end-to-end manner, this information may be carried in SIP messages.

The collect call information may also be received from the B-party even in cases where this has not been requested by the A-party. From FIGS. 3 and 4 it can be seen that collect call information from B-party may be made available when the first SIP ‘183’ message is received from the B-party. If a charging request (for example, ‘START RECORD’ or INITIAL REQUEST’) has already been sent to A-party charging entity based on the SIP ‘INVITE’ message from the A-party, the SIP ‘183’ message may trigger an update of that request (e.g. ‘INTERIM RECORD’ or ‘UPDATE REQUEST’) with collect call parameters even in instances wherein the A-party has not requested for the reverse charging. This could be used, for example, for free phone type services.

The B-party activates the service when the SIP ‘INVITE’ message from the A-party is received. At that stage the B-party may include with the response message information regarding the conditions for the reversed payment. For example, the B-party may include information regarding how the charges are to be divided, charging layer specific condition information such as who pays for the access, the IMS part, and so on. For example, it can be defined that the B-party pays half of the cost, or that the party pays all charges and so on. This may be implemented by means of charging information elements such as ‘Shared-Charging-Information’, ‘Shared-Percentage’, ‘Sponsor-Identity’ (B-party identity) and so on. This information may then be used by the A-party S-CSCF for instructing the appropriate charging entity.

The A-party S-CSCF may also inform the A-party that the session is free of charge. For example, a ‘free of charge’ information may be included to the SIP ‘183’ message to the A-party. This information may be included, for example, in the subject field of the message.

An intelligent negotiation mechanism may also be used. The A-party may accept or reject the B-party's offer for paying or sharing the cost when a SIP ‘183’ message is received. If A-party charging has been started from the first SIP ‘INVITE’ message, the SIP ‘200OK’ or ‘UPDATE’ message could trigger a new accounting request. For example, an ‘INTERIM RECORD’ or ‘UPDATE REQUEST’ message could be sent to the charging entity with the required ‘collect call’ parameters. The B-party may also include information regarding the terms of acceptance (for example, accepted partially) in the SIP response message which the A-party then, in turn, needs to accept.

The B-party may also be provided with cost information from the A-party charging entity. This information may be included in the SIP messages to the B-party.

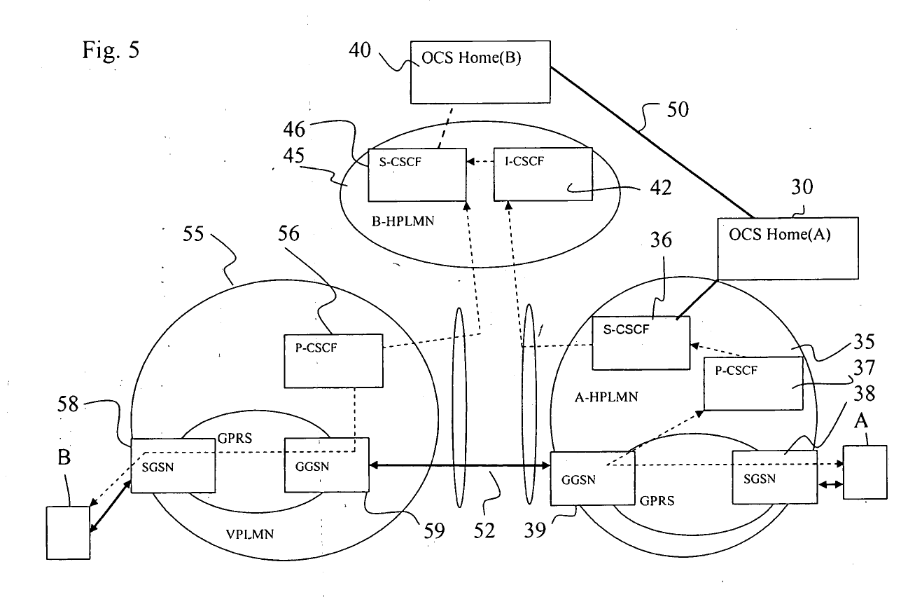

FIG. 5 shows an embodiment wherein entities of three networks 35, 45 and 55 are involved in the provision of the session between parties A and B. The A-party is serviced by his home public land mobile network (HPLMN) 35, i.e. by the network the A-party subscribes to. In FIG. 5 the signalling for the session set-up is shown by the dashed line. The actual session set-up based on the set-up signalling is shown by a solid line 52. As shown, the actual communication between the user equipment A and B occurs directly between the Gateway GPRS (General Packet Radio Service) support nodes 39 and 59 interfacing the networks 35 and 55.

As is shown, the session step-up may be handled by a plurality of call state control function entities (CSCFs) 36, 37, 42, 46, and 56. The functions of the proxy CSCFs and the interrogating CSCFs are known in the art, and will thus not be described in more detail.

The call state control function entity 36 is serving the A-party, i.e. the A-party has registered at least one identity at the entity 36. Communications to and from the A-party user equipment are handled by a serving general packet radio service support node 38.

The B-party, in turn, has roamed from the home network 45 to a visited network 55. Communications to and from the B-party user equipment are handled by a serving general packet radio service support node 58 of the visited network. However, the serving call state control function 46 the B-party is registered at as well as the B-party charging entity 40 are located in the home network 45 of the B-party. As can be seen from FIG. 5, the interface between the charging entities 30 and 40 is not dependent on the networks where the parties are located. The collected charging data may be communicated to an appropriate charging entity based on the address information provided by the parties. Therefore the embodiment enables establishment of a charging session 50 between the charging entities 30 and 40 even in the cases where at lest one of the parties has roamed into a visited network.

The above described embodiments relate to a situation where the A-party charging entity was made aware of the details of the B-party charging entity. It is also possible to include information regarding the A-party charging entity 30 for example in the SIP ‘INVITE’ message, and then send this from the S-CSCF servicing the B-party to the B-party charging entity 40. This may be done after an approval message from the B user equipment. The interface between the charging entities 30 and 40 could then be set up by the B-party charging entity 40.

The above described embodiments may enable online charging for divided or reversed charging. The embodiments may enable the A-party charging entity 30 and B-party charging entity 40 to communicate with each other. Divided charging or corresponding information and B-party charging entity address can be inserted to appropriate messages during the set-up signalling. The A-party charging entity can be seen as acting as a client of the B-party charging entity.

The B-party user equipment may be configured to generate at least a part of the information content of a charging information element (CIE). The network entities, such as the B-party serving call state control function entity 46 may be configured to include further required data in the response message.

It shall be appreciated that arrangements where the required information is already inserted at the B-party user equipment are also possible. This may involve that the information enabling the set-up an interface between the charging entities 30 and 40 is available for the B-party user equipment. This may be provided, for example, by storing information associated with the serving charging entity in the memory of the user equipment or by requesting such information from the network, such as from the serving controller 46.

It is noted that the above disclosed solution is applicable both to postpaid charging and prepaid charging. The main difference between the postpaid and the prepaid charging would be that instead of monitoring and deducting a prepaid balance, in the postpaid charging the charges would accumulate in the charging records of the B-party based on communication on the interface between the A-party and B-party charging entities.

It shall be appreciated that although the examples assume that charging is started from a SIP ‘INVITE’ message, this is not the only option. For example, charging can be started in response to a SIP ‘200OK’ message. In this case no updating between the different SIP messages is needed.

It should be appreciated that whilst embodiments of the present invention have been described in relation to user equipment such as mobile stations, embodiments of the present invention are applicable to any other suitable type of user equipment.

The embodiments of the present invention have been described in the context of a third generation system and Session Initiation Protocol. This invention is also applicable to any other communication systems and protocols where appropriate.

The embodiments of the invention have discussed the interface between two charging entities. However, the present invention is also applicable to other network elements where appropriate. For example, the mechanism could be used for other control features, such as for negotiating appropriate Quality of Service (QoS) level for a session between two parties.

It is also noted herein that while the above describes exemplifying embodiments of the invention, there are several variations and modifications which may be made to the disclosed solution without departing from the scope of the present invention as defined in the appended claims.

1. A method for charging in a communication system, the method comprising the steps of:
initiating set-up of a communication session between a first party and a second party by sending from the first party to the second party a message inviting the second party to join the communication session, the first party being served by a first charging entity and the second party being served by a second charging entity;
sending a response to the message, the response including information regarding the second charging entity;
based on the response, providing the first charging entity with information regarding the second charging entity; and
establishing a communication interface between the first and second charging entities based on the information included in the response.

2. A method as claimed in claim 1, comprising the further step of charging the second party based on information communicated on the communication interface.

3. A method as claimed in claim 2, wherein the step of charging comprises decreasing a prepaid balance of the second party stored by the second charging entity.

4. A method as claimed in claim 2, wherein the step of charging comprises adding charges on a subscriber account of the second party maintained by the second charging entity.

5. A method as claimed in claim 1, comprising the steps of including information regarding the second charging entity in the response at a controller entity serving the second party.

6. A method as claimed in claim 1, comprising the step of including at least a part of information required for the establishment of the communication interface between the first and second charging entities into the response by the second party.

7. A method as claimed in claim 1, wherein sending the response comprises signalling of the response on at least two networks.

8. A method as claimed in claim 1, wherein the message inviting the second party includes an indication that the second party is requested to pay for at least a part of charges for the communication session.

9. A method as claimed in claim 6, comprising the further step of including at least one condition for payment by the second party.

10. A method as claimed in claim 1, wherein the communications system comprises at least an Internet Multimedia Subsystem.

11. A method as claimed in claim 1, wherein a call state control function serving the first party provides the first charging entity with the information regarding the second charging entity.

12. A method as claimed in claim 1, wherein the information regarding the second charging entity comprises at least the address of the second charging entity.

13. A method as claimed in claim 1, comprising sending the response in a session initiation protocol message.

14. A communication system comprising:
a first charging entity configured to charge a first user equipment for use of communication resources provided by the communication system;
a second charging entity configured to charge a second user equipment for use of communication resources provided by the communication system;
a first control entity configured to serve the first user equipment;
a second control entity configured to serve the second user equipment;
wherein at least one of the first and second control entities is configured to provide the associated charging entity with information regarding the other charging entity, and, in response to receiving such information, to initiate set-up of a communication interface between the first and second charging entities.

15. A user equipment configured to include information regarding charging of a session in a message generated in response to an invitation to join the session.

16. A network entity configured to serve a first user equipment, to provide a first charging entity serving the first user equipment with information regarding a second charging entity serving a second user equipment in response to receiving such information from a controller serving the second user equipment.

17. A network entity configured to serve a user equipment and to include into a message from the user equipment to another network entity information regarding a charging entity serving the user equipment.

18. A charging entity for a communication system, the charging entity being configured to serve a first user equipment and to communicate with another charging entity configured to serve a second user equipment, the communication being based on information regarding the second charging entity and received from a controller of the communication system.
